(19) United States
(12) Patent Application Publication
(10) Pub. No.: US 2006/0190327 A1
(43) Pub. Date: Aug. 24, 2006

(54) Method and apparatus for encouraged visitation web advertising

(76) Inventor: Jack Ivan Jmaev, Chino, CA (US)

Correspondence Address: INTELLECTUAL PROPERTY DEVELOPMENT;JACK IVAN J'MAEV, 14175 TELEPHONE AVE., SUITE L, CHINO, CA, 91710, US

(21) Appl. No.: 11/314,944

(22) Filed: Dec. 20, 2005

Related U.S. Application Data
(63) Continuation-in-part of application No. 10/615,345, filed on Jul. 7, 2003.
(60) Provisional application No. 60/394,980, filed on Jul. 9, 2002.

(51) Int. Cl. G06Q 99/00; G07G 1/14; G06Q 30/00

(52) U.S. Cl. 705/14; 705/1

(57) ABSTRACT

A method for advertising over the Internet by first sending a notice to a product. A receiver integrated in the product receives the signal and an indication is presented to a user. The user then responds to the indication by visiting a web site.

### RELATED APPLICATIONS

The present application claims priority to PCTUS2004/019997 entitled “Method and Apparatus for Encourage Visitation Web Advertising”, by J'maev, filed with the US Receiving Office on 21 Jun. 2004 which itself claims priority to U.S. Provisional Application 60/480,585 filed on 21 Jun. 2003; this application is also a continuation-in-part of U.S. application Ser. No. 10/615,345—“Method and Apparatus for Issuing Product Notices”, by J'maev filed on Jul. 7, 2003 and which claims priority to Provisional Application No. 60/394,980 also by J'maev.

### BACKGROUND

By this time, most everyone knows that the whole “dot.com” thing just didn't pan out. Throughout the entire life cycle of the dot.com era, one thing remained a painful reality. As powerful as web-based advertising could be, people needed to visit the web site in order to see any advertisements. This really plagued dot.com companies. With only minor exceptions, the revenue model for all of these dot.com companies was predicated on the need to sell advertising opportunities to sponsors. Despite the true purpose of any web site, advertising dollars were the key to success.

Hence, the dilemma. How to encourage people to visit the dot.com company's web site. The obvious answer—ADVERTISE!!! What a vicious spiral!!! What was the point??? Here were all of these dot.com companies trying to draw people to their websites so that they could make all of this money selling advertisements. Unfortunately, the dot.com companies had to spend tons of money advertising their web site to make them popular. The frenzy of radio and television ads run by dot.com companies finally led to their demise as one web paradigm after another succumb to the ruthless vampire of advertising. In the end, dot.com companies were spending more money advertising their web sites than they were bringing in as revenue from others that were willing to advertise on the web site.

The real problem that dot.com companies faced was that, unlike traditional media, the common person had no real way of finding a web site. Search engines were of little help because even the most popular web sites still didn't pop-up often enough to make desired revenue goals. The advertisers that wanted to advertise on the web site simply demanded more and more exposure. In a sense, the only real web sites that could make money were the search engines themselves. After all, while someone was trying to find someone else's web site, the search engine had first dibs on the Internet user—that user was already visiting the search engine site and was a prime advertising target. So, the traditional media of radio television, and to some extent newspapers and magazines, were the only real way to encourage Internet users to visit a particular website. And, the web site had to have some real utility to the user.

Had the dot.com craze overcome this problem of drawing users to web sites, then things might be different today. The Internet could have matured into a legitimate media drawing both users and sponsors willing to pay for Internet advertisement. This is really tragic since the Internet could have been the ultimate demographically targeted media of this millennium.

### SUMMARY

A method for encouraging a user to visit a web site comprising issuing a signal to a receiver integrated into a product wherein said receiver comprises a notification means for informing a user that a notice has been received.

### BRIEF DESCRIPTION OF DRAWINGS

Several alternative embodiments will hereinafter be described in conjunction with the appended drawings and figures, wherein like numerals denote like elements, and in which:

FIG. 1 is a flow diagram that depicts one example method for presenting Internet advertisements to a user once the user has been encouraged to visit a web site according to the present invention;

FIG. 1A is flow diagram of one alternative method for encouraging a user to visit a web site according to the method of present invention;

FIG. 1B is a flow diagram that depicts one alternative method for encouraging a user to visit a web site according to the present invention;

FIG. 2 is a flow diagram that further describes one illustrative method for receiving a product identifier according to the present invention;

FIG. 3 is a flow diagram that depicts one alternative method for receiving a product identifier according to the present invention;

FIG. 4 is a flow diagram that depicts one example method for preparing a web page in response to receipt of a manufacturer selection;

FIG. 5 is a pictorial diagram that depicts one possible structure of a table used by the method of the present invention to organize advertisements by product categories;

FIG. 6 is a pictorial representation of an example embodiment of a product category/maker advertisements table;

FIG. 7 is a pictorial representation of one example embodiment of a product notice table that is used according to one method of the present invention for storing product notices;

FIG. 8 is a block diagram that depicts one example embodiment of a web server that is capable of presenting electronic advertisements to a user according to the method of the present invention;

FIG. 9 is a data flow diagram that depicts the operation and interaction of various functional modules executed by the processor 305 comprising the web server of the present invention;

FIG. 10 is a message diagram that depicts one illustrative use case wherein electronic advertisements are provided to a user according to the method of the present invention;

FIG. 11 is a pictorial representation of one example embodiment of a product selection web page constructed according to a temple by the web page constructor of the present invention; and

FIG. 12 is a pictorial representation of one example embodiment of a product notice web page prepared for a user by the web page constructor of the present invention.

### DETAILED DESCRIPTION

The Applicant has developed novel technology, collectively known as product-centric user notification, that enables the dispatch of product notices such as, inter alia, recall notices and upgrade notices directly to a product. This technology is described in the incorporated reference, application Ser. No. 10/615,412 filed on Jul. 7, 2003, entitled “Method and Apparatus for Receiving Product Notices”, by J'maev, currently pending.

The present invention comprises a method for the presentation of advertisements on the Internet that includes an inherent step for encouraging users to visit the target Internet web site. The present invention further comprises an apparatus that implements the teachings of the present method.

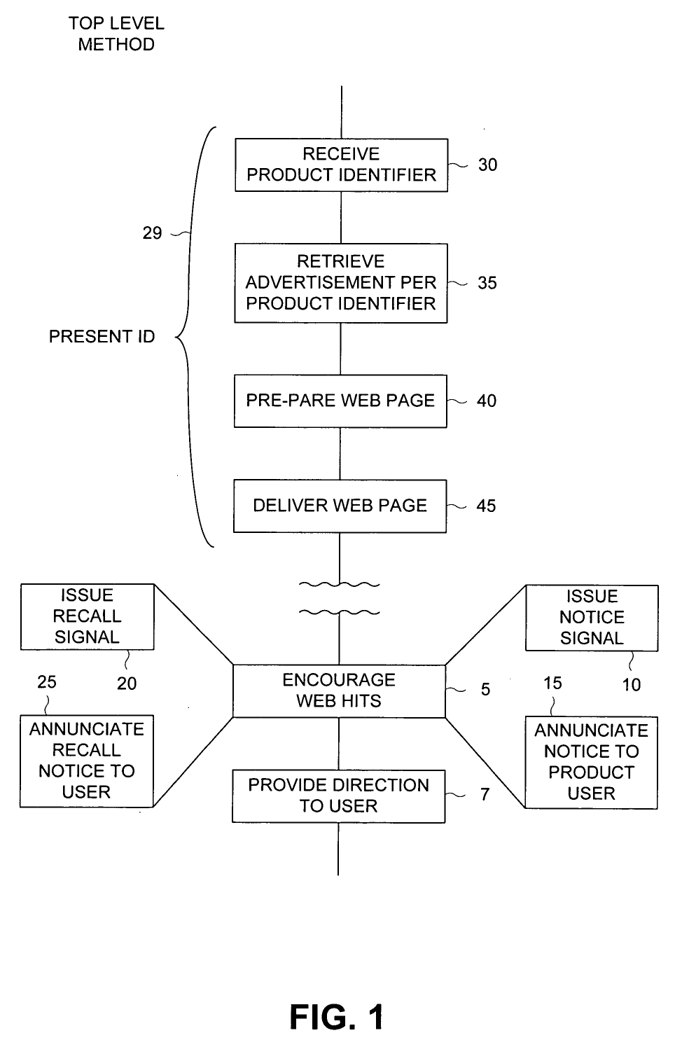

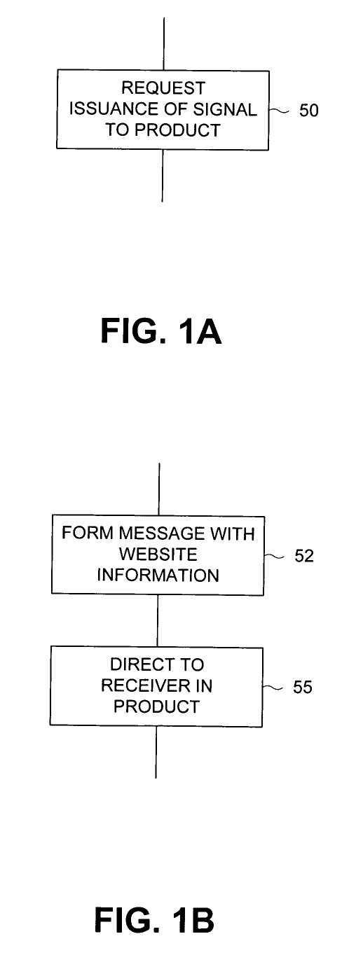

FIG. 1 is a flow diagram that depicts one example method for presenting Internet advertisements to a user once the user has been encouraged to visit a web site according to the present invention. According to one example method, this is accomplished by first encouraging a user to visit a particular web site through a product notification means (step 5). According to one example variation of the invention, the encouragement takes the form of issuing a product notice signal to a product (step 10) and then providing some indication to a user that the notice has been received by the product (step 15). The notice, at least according to one alternative method, comprises a product recall notice (step 20). Then, the recall notice is presented to the user (step 25) (i.e. the user is made aware of the notice). The present method further provides for directing the user to a web site when the user is made aware of the product notice (e.g. is annunciated to the user). This can be accomplished by varied means, but one illustrative method provides for product indicia directing the user to a specific web site when a product notice is received by a product. Accord yet another example method of the present invention, the product notice delivered to the product contains an indication of what web site the user is encouraged to visit. This indication is presented to the user, at least according to one alternative illustrative method, in a textual form.

It should be noted that any type of notice may be issued to the product and the example of a recall notice is merely for the purpose of illustrating the invention and not to limit the intended scope thereof. According to other variations of the present method, product notices include, but are not necessarily limited to product upgrade notices and product related advertising notices.

Upon arrival of a user at the specific web site (as specified by the product indicia or, in an alternative method by means of web site information in the product notice directed to the product), an advertisement is presented to the user (step 29). According to one variation of this method, presentation of an advertisement is accomplished according to the type of product by which the user received a product notice. For example, one method provides for receiving a product identifier (step 30) and then provides for the demographic retrieval of an advertisement based on the product identifier (step 35). A web page comprising the retrieved advertisement is prepared (step 40) and delivered to the user (step 45). It should be noted that one example method of the invention provides that the product identifier is received by interaction with the user when the user first enters the web-site. For example, this can be accomplished through a series of questionnaires that help the user identify the product that drew them to the web site. In yet another alternative method, the user is asked to provide a product digital identifier for the product in question. In this case, the step of providing some indicia on the product is augmented by a step for providing a user with this product digital identifier. This could be accomplished by additional indicia on the product (e.g. a product digital identifier on a label adhered to the product).

FIG. 1A is flow diagram of one alternative method for encouraging a user to visit a web site according to the method of present invention. According to this alternative method, a web site is either owned or operated by an independent agent. Accordingly, the independent agent is an entity that sells advertising on a web site. An independent agent, according to the present invention, includes, but is not limited to a manufacturer that operates a web site that describes products that the manufacturer produces, a search engine web site or any other independent web site wherein the independent agent sells advertising on the web site.

According to this illustrative variation of the present method, the independent agent requests issuance of a signal to a product as a means of encouraging users to visit a web site. According to this alternative method, a second party responds to the request and actually issues a signal to the product in order to encourage users to visit the web site. According to one example alternative method, the request for issuance comprises web site information that the second party includes in the signal disseminated to the product. The second party may be a service provider that is capable of issuing a signal to a receiver integrated in a product. The independent agent requests issuance of a signal to the product, according to one illustrative method of the present invention, by manual means (e.g. by telephone call or by interaction with a web site). The reader is encouraged to review the incorporated references wherein is presented a description of a web site that facilitates the issuance of product notices to a product. According to yet another alternative method, the independent agent issues the request by automated means. According to one example method, an electronic system (e.g. a computer) operated by the independent agent generates an electronic message that is then conveyed to an electronic system (e.g. a computer) operated by the service provider. The electronic system operated by the independent agent and the electronic system operated by the service provider, according to one alternative method, communicate by means of a wide area network (e.g. the Internet). The request to issue a product notice, according to yet another alternative method, further comprises a target product group (wherein the target product group is defined in the incorporated references).

It should be noted that one illustrative method of the present invention comprises the request to issue a product notice to a product and not the actual issuance itself. Hence, a web site operator would infringe the appended claims by requesting that a product notice be issued to a product. It should be further noted that an alternative method provides for the additional step of issuing the product notice to the product.

FIG. 1B is a flow diagram that depicts one alternative method for encouraging a user to visit a web site according to the present invention. According to this alternative method, a message that includes web site information is formulated (step 52) and is directed to a product. According to one alternative example method, a message is directed to a product by directing the message to a receiver integrated in a product (step 25). According to yet another alternative method, the message is formulated to include a product target group (as defined in the incorporated references).

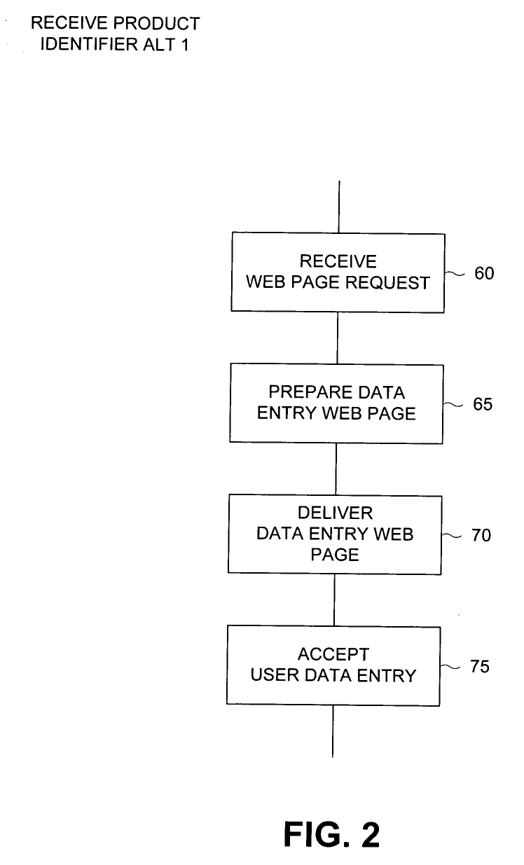

FIG. 2 is a flow diagram that further describes one illustrative method for receiving a product identifier according to the present invention. According to this one illustrative method, a request for a web page is received (step 60) after a user is encouraged to visit the web site according to the teachings of the present method. An advertisement, according to one illustrative method, is included in the first web page presented to the user. For example, the homepage of a web site also includes an advertisement, but this is optional. This homepage, according to one alternative method, includes a data entry control that the user uses to enter information about the product that received a product notice. Hence, according to one illustrative method of the present invention, a data entry web page is prepared (step 65) in response to the web page request received from the user. This data entry web page is delivered to the user (step 70) once it is prepared. Once the data entry web page is completed by a user, it is submitted and user data entry found in the data entry web page is accepted (step 75). Whenever any presentation is made to the user, for example presentation of the data entry web page, at least one Internet advertisement is presented to the user, again this is optional. This advertisement need not be based on the type of product that received a product notice (thereby encouraging the user to visit the web site). Of course, the scope of the present invention is not intended to be limited in any manner. For example, a method that does not include presentation of an advertisement in a particular web page presented to the user is still considered to be within the scope of the present invention. Hence, the true nature of the present invention is to provide advertising based on information received from a user once the user is encouraged to visit the web site by means of a product notice received by a product and that ultimately encouraged the user to visit the web site.

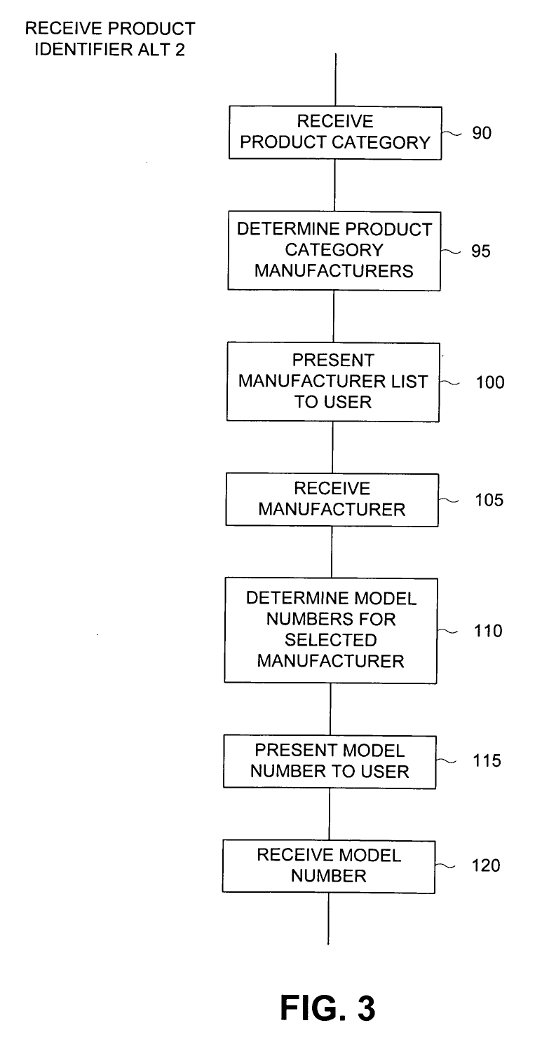

FIG. 3 is a flow diagram that depicts one alternative method for receiving a product identifier according to the present invention. According to this alternative example method, a product category is received from a user (step 90). Once this is received, this example method provides for determining what manufacturers are likely producers of products in this category (step 95). A list of these manufactures is then presented to a user (step 100). This list is typically used as the basis for selection of one manufacturer. A manufacturer identification is subsequently received from the user (step 105). Once a manufacturer of the product that has drawn the user to the web site is received (i.e. specified by the user), a list of products manufactured by the determined manufacturer that correspond to the product category received from the user is prepared (step 110). The list of products in the product category that are manufactured by the manufacturer are then presented to the user (step 115). Then, an actual product identifier is received from the user (step 120) as the user selects one product from the presented list of products. What is important to note is that the interaction with the user to obtain a product identifier is a key feature of the invention, since each interactive step provides an opportunity to present a new Internet advertisement to the user. Accordingly, where presentations are made to the user, one example method includes one or more Internet advertisements that are presented to the user (i.e. along with steps 100 and 115). It should be noted that the true spirit of the present invention is reflected in a method for encouraging a user to visit a web site and then presenting advertisements to the user. Additional features of interacting with the user in order to provide more advertising opportunities and that the user was encouraged to visit the web site through a product notice issued to a product are alternative methods of the present invention.

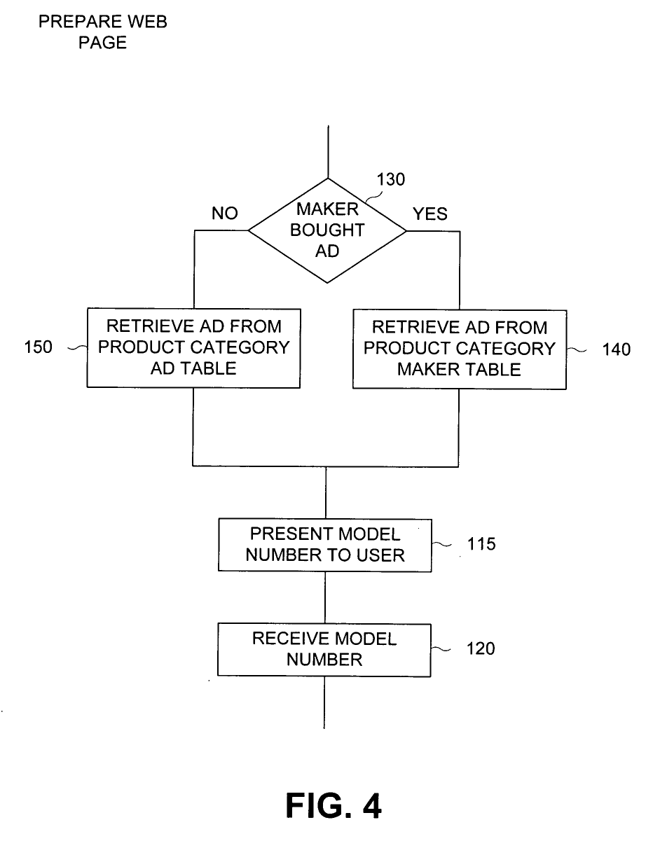

FIG. 4 is a flow diagram that depicts one example method for preparing a web page in response to receipt of a manufacturer selection. At any juncture in the advertising process where more information is obtained from the user through such user interaction, advertisements are selected according to information obtained through the interaction. For example, one illustrative method provides that as soon as a manufacture is identified by the user, an advertisement is selected according to this information. According to yet another variation of this method, the advertisement is selected according to the manufacturer identified by the user and additional information also known by means of interaction with the user.

According to one illustrative method, which is of particular interest, the fact that the user has identified a manufacture of a particular product is used to determine if that manufacturer has purchased advertising rights on the web site (step 130). If so, an advertisement is selected according to the manufacturer identified by the user (step 140). According to yet another alternative method, additional information is used collectively with the manufacturer information to select the advertisement. For example, one alternative method provides that manufacturer identified by the user is used collectively with a product category in order to select an advertisement (step 140). If, on the other hand, the identified manufacturer has not purchased advertising rights on the web site, a generic advertisement is presented to the user (step 150). According to yet another illustrative method of the present invention, the product category selected by the user is used to retrieve an advertisement for presentation to the user in this step of the method.

One alternative method of the present invention further provides that substance relating to the original product notice that was used to encourage the user to visit the web site is also retrieved (step 160). The product notice information that used to assemble web page (step 170) that is presented to the user.

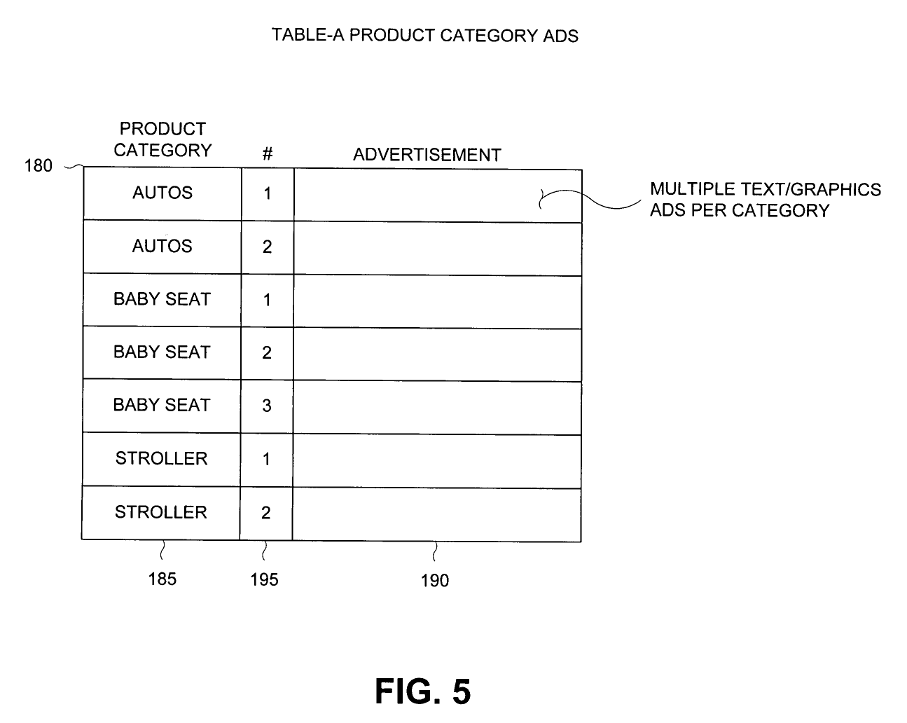

FIG. 5 is a pictorial diagram that depicts one possible structure of a table used by the method of the present invention to organize advertisements by product categories. According to one illustrative embodiment of the present invention, a product category advertisements table 180 comprises a product category field 185 and an advertisement field 190. According to yet another illustrative embodiment of the present invention, the product category advertisements table 180 further comprises an advertisement identification field 195. According to this illustrative embodiment, the advertisement identification field 195 is used to discriminate between multiple advertisements stored multiple records in the product category advertisements table 180 wherein the same product category is stored in the product category field 185 of each of these records.

According to one illustrative use case, which is not intended to limit the scope of the invention and is depicted in FIG. 5, three records are stored in the product category advertisements table 180 for the product category “baby seat”. These three records are discriminated by an ordinal value stored in the advertisement identification field 195. It should be noted, that though the advertisement identification field 195 is used to distinguish between a plurality of records in the product category advertisements table 180 having the same product category value stored in the product category field 185, other illustrative methods utilize only be product category field 185 and the advertisement field 190. In this case, one example method of the present invention relies on dissimilarity in the actual advertisement stored in the records to distinguish among records. The present description describes the advertisement field 190 as a field that is used to store an advertisement for a particular product category. However, alternative example methods provide that the advertisement field 190 is used to store a reference (e.g. a pointer) to the actual advertisement. All of these variations of the present method are intended to be within the scope of the claims appended hereto. Again, it should be noted that the scope of the present invention is to include all variations of methods wherein a user is encouraged to visit a particular web site by means of a product notice issued to a product.

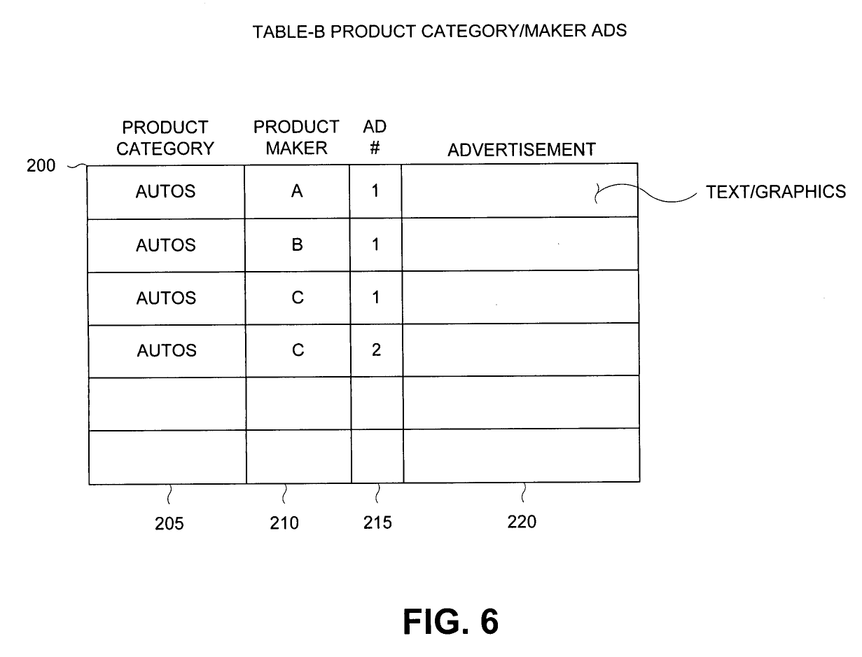

FIG. 6 is a pictorial representation of an example embodiment of a product category/maker advertisements table. According to this example embodiment of the present invention, a product category/maker advertisements table 200 comprises a product category field 205 and a product maker of the field 210. According to one example method, for example the illustrative method depicted in FIG. 4, once a product category and a product of manufacture have been determined (i.e. selected by a user through interaction with the web site), the method determines whether or not a particular manufacture has purchased advertising rights on the web site by consulting the product category/maker advertisements table 200.

According to one illustrative method, the product maker field 210 and the product category field 205 are used to determine whether or not a particular manufacturer has purchased advertising rights on the web site (i.e. there's a record matching the determined product manufacturer and product category fields). If so, an advertisement is retrieved from the product category/maker advertisements table 200, specifically from the advertisement field 220. In the case where more than one advertisement has been purchased by a particular manufacturer, the product category/maker advertisements table 200 further comprises an advertisement number field 215 that is used to distinguish amongst a plurality of records having the same product category and product maker values stored in respective fields in a plurality of records stored in the table 200. According to one example alternative method, a plurality of records having the same product category and product maker values stored in respective fields in the table are distinguished by variance in the advertisement value stored in the advertisement field 220. According to one example method of the present invention, the advertisement field 220 is used to store an actual advertisement (e.g. text and/or graphics). According to yet another alternative method, the advertisement field 220 is used to store a reference to the actual advertisement.

Again, it should be noted, that one key feature of the present invention is that of encouraging a user to visit a particular web site by issuing a product notice to product. Selection of advertisements is an optional step and may be accomplished varied manners. Any such means for selecting advertisements is within the scope of the present invention.

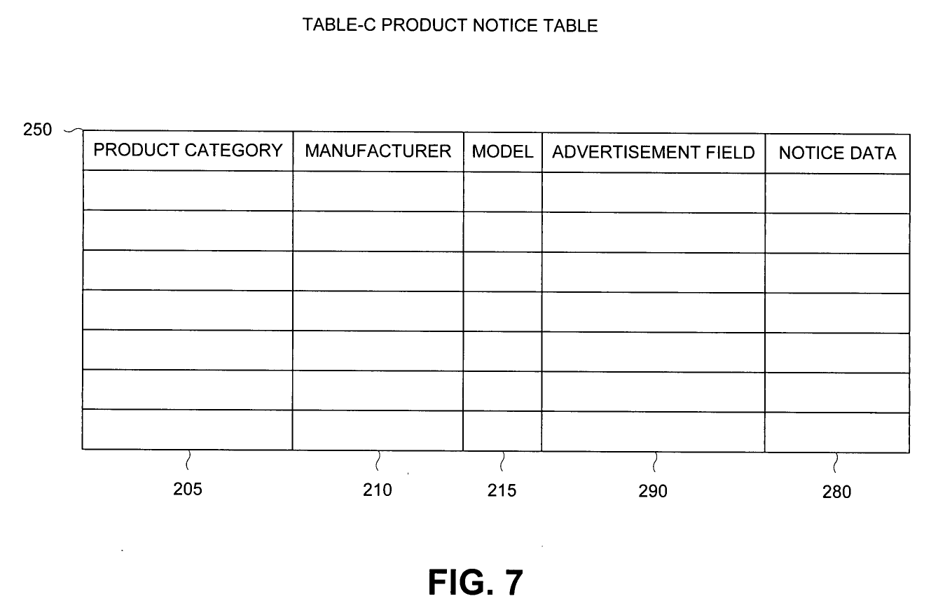

FIG. 7 is a pictorial representation of one example embodiment of a product notice table that is used according to one method of the present invention for storing product notices. According to one illustrative method, a product notice is retrieved and presented to a user once a product category, a manufacture, and a model number have been determined. To support this, one alternative embodiment in the invention utilizes a product notice table 250 comprising the product category field 255, a manufacture of field 260 and a model field 270. One alternative method requires that the product notice table further comprise a notice field 280. Accordingly, product category, manufacture and model number are used to select a particular record in the product notice table 250. Once the proper record is selected, a product notice is retrieved from the notice field 280. According to yet another alternative method, the product notice table further comprises an advertisement field 290. According to one illustrative method, once the product category, manufacture and model of a particular product have been determined through interaction with the user, an advertisement is retrieved from the advertisement field 290 comprising the product notice table 250. As in other example methods taught here, the advertisement field 290 is used to store either of an advertisement or a reference to said advertisement. According to yet another alternative method, the notice field 280 is used to store either of an actual notice or a reference to said notice.

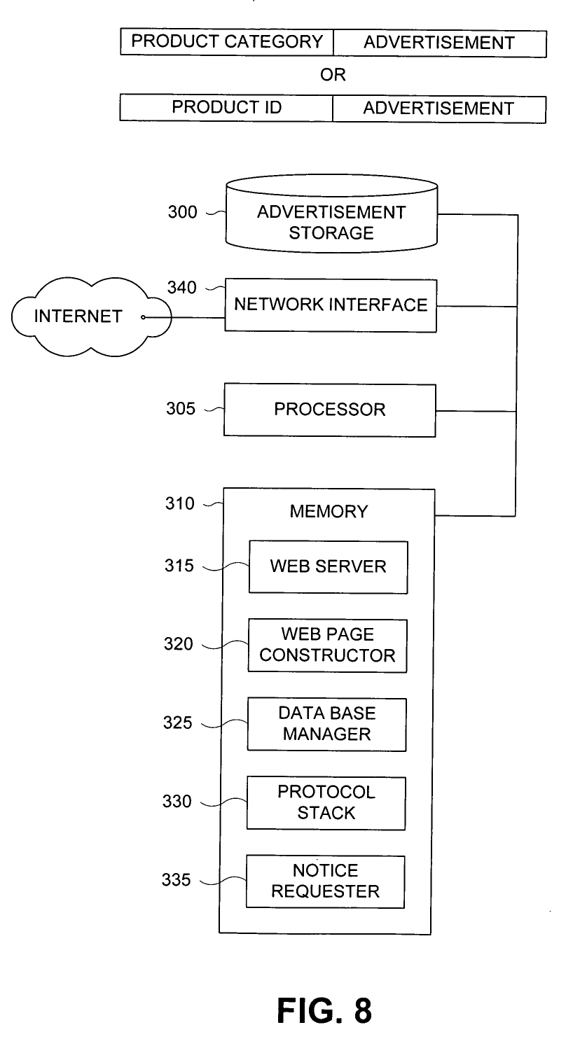

FIG. 8 is a block diagram that depicts one example embodiment of a web server that is capable of presenting electronic advertisements to a user according to the method of the present invention. According to this example embodiment, a web server comprises a processor 310, a memory 310 and a network interface 340. The web server further comprises various functional components embodied as software modules. Generally, these functional software modules are loaded into the memory 310 enabling the processor 305 to execute each of the functional modules. According to one example embodiment, the web server further comprises a web server module 315, a web page constructor module 320, a database manager module 325 and a protocol stack 330. According to one alternative embodiment, the web server further comprises a notice requester module 335. According to yet another alternative embodiment, the web server further comprises data storage 300 the form of computer readable media (CRM).

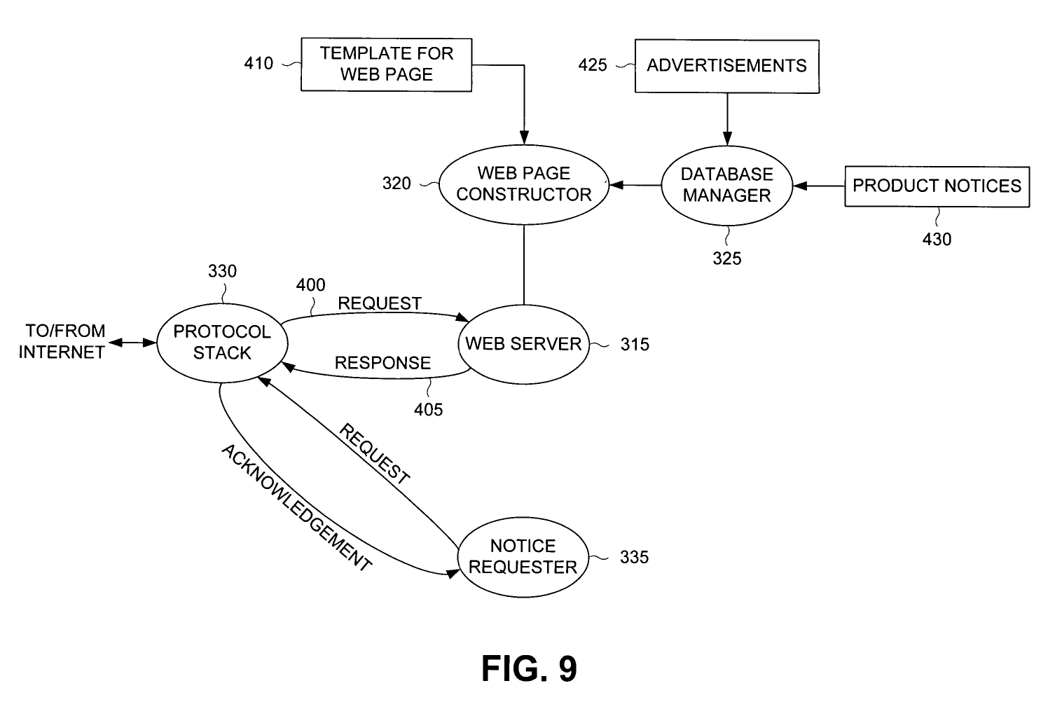

FIG. 9 is a data flow diagram that depicts the operation and interaction of various functional modules executed by the processor 305 comprising the web server of the present invention. According to one example embodiment, the web server module 315 interacts with a wide area network (e.g. the Internet) by means of the protocol stack 330. The protocol stack 330, according to one example embodiment, implements a transmission control protocol/Internet protocol (TCP/IP) protocol. However, any suitable protocol may be implemented by the protocol stack 330.

According to this example embodiment, the web server module 315 receives a request 400 for a web page. In response, the web server 315 requests a web page from the web page constructor 320. The web page received from the web page constructor 320 is directed to the user as a response 405 to the web page request 400. Generally, the web page constructor 320 receives a template 410 for a web page. Template 410 specifies the type of information that should be included in a web page delivered to the web server 315. In order to construct the web page, the web page constructor 320 uses the template 410 as a guide for requesting information from the database manager 325. According to one example embodiment, the web page constructor 320 retrieves advertisements 425 by issuing requests to the database manager 325. According to yet another alternative example embodiment, the web page constructor 320 retrieves product notices 430 by issuing requests to the database manager 325. The database manager, according to one example embodiment, is a structured query language (SQL) server. According to yet another example embodiment, advertisements 425 are stored on computer readable media 300 comprising the web server. According to yet another example alternative embodiment, product notices 430 are stored on computer readable media 300 comprising the web server.

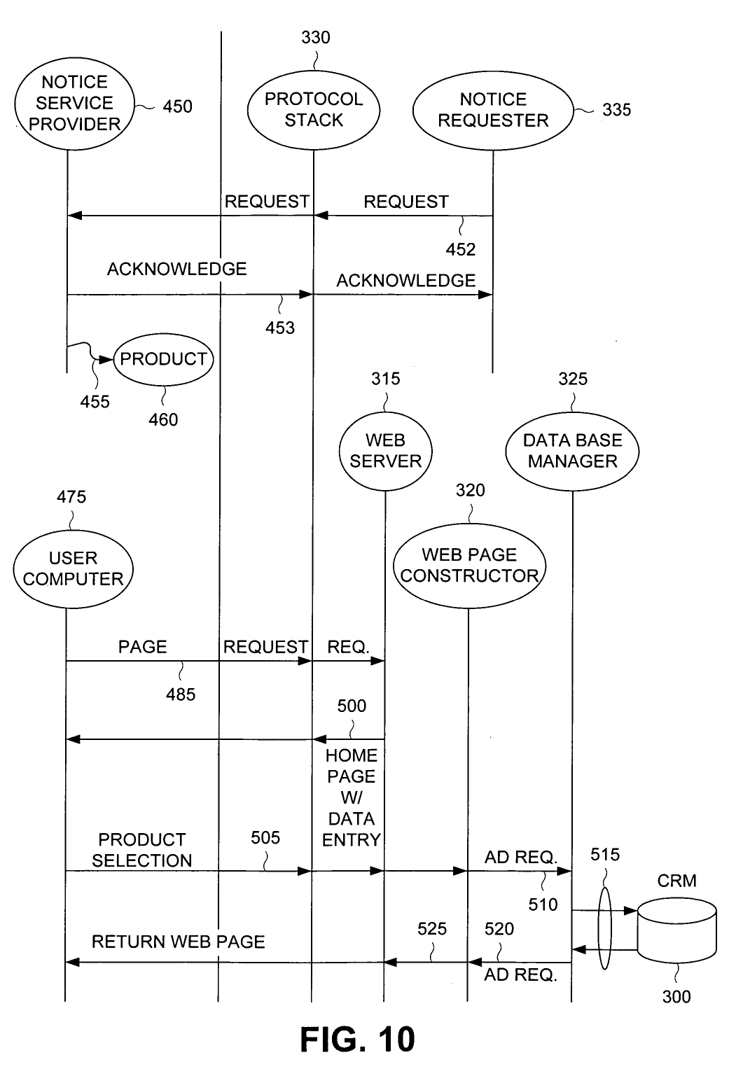

FIG. 10 is a message diagram that depicts one illustrative use case wherein electronic advertisements are provided to a user according to the method of the present invention. According to this one example use case, the presentation of which is not intended to limit the scope of the present invention, a user is encouraged to visit a web site according to the teachings of the present method. This, according to one embodiment, occurs by manual means—e.g. a human operator makes a phone call to a service provider or interacts with a web site operated by the service provider. Hence, a request for a product notice is issued. In response, the service provider 450 issues a notice 455 to a product 460 (wherein a product is defined to be one or more products in a targeted group of products).

According to one alternative embodiment of the invention, the web server further comprises a notice requester module 335, that when executed by the processor in the web server causes the processor to perform at least the function of dispatching a notice request 452 to the service provider 450. The notice request 452, according to this illustrative use case of the invention, is conveyed through a wide area network by means of a network protocol. Therefore, the actual conveyance of the notice request 452 is managed by the protocol stack 330. According to one example use case, the notice service provider 450 issues an acknowledgement back to the protocol stack 330. This acknowledgement is then propagated to the notice requester 335. It should be noted that the acknowledgment phase of this transaction is entirely optional. Once the notice server provider 450 receives a notice request, it issues a product notice 455 to a product 460. Again, a product is defined to be one or more products in a targeted group of products.

Once a product notice reaches a product, some means of notifying a user that the notice has been received is employed to gain the user's attention. This said, the user is encouraged to visit the subject web site either by means of indicia on the product, for example “when the red light flashes—visit www.readytrace.com”. In an alternative embodiment of the invention, the product notice request sent to the service provider 450 includes web site information. Accordingly, this web site information is presented to the user as a means of encouraging the user to visit the web site.

Properly encouraged, a user (using a user's computer 475) sends a request for a web page to the web server (315). The reader is reminded that the entire process of requesting a web page (e.g. interaction with a domain name server to translate a universal resource locator (URL) to a physical address and the workings of a browser executing in the user's computer) is not specifically described here because techniques for issuing a web page request are well known in the art. The web page request is first received by the protocol stack 330 comprising the web server as a series of protocol packets. These protocol packets are processed in order to produce a coherent request that the web server module 315 can appreciate. In response, the web server module 500 provides a home page web page. According to one illustrative use case, the home page comprises a data entry control that can be used by a user to specify one or more or a product category, a product maker, a product model number and a product digital identifier. Hence, the user identifies a product using one or more of these identifiers and directs this as a product selection 505 back to the web server module 315.

In further description of this one illustrative use case, which is not intended to limit the scope of the claims appended hereto, the product selection 505 is forwarded by the web server module 315 to the web page constructor 320. The web page constructor then retrieves a template and retrieves information from a database according to the product selection. According to one illustrative embodiment, the web page constructor 320 forms a data request according to the product selection and directs the data request 510 to the database manager 325. The database manager services the request by retrieving the request data from a table stored in a database. Generally, the database is physically stored on CRM 300 comprising the web server. However, the database manager 325, according to one embodiment, interacts with data stored in another computer. According to yet another embodiment of the invention, the database manager 325 is also executed in a different computer. In such case, the request for data 510 is directed to the protocol stack 330. The protocol stack directs the request to a computer network so that is can be directed to the remotely executing database manager. Once the web page constructor 320 has obtained information (e.g. an advertisement), it produces a web page and directs this web page 525 back to the user's computer 475.

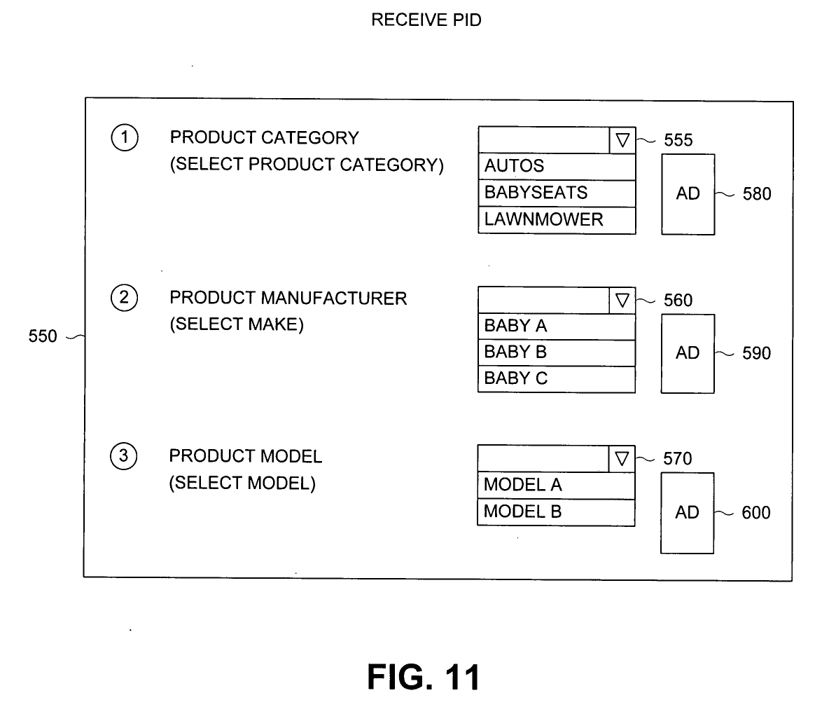

FIG. 11 is a pictorial representation of one example embodiment of a product selection web page constructed according to a temple by the web page constructor of the present invention. According to one illustrative use case of a template, a product selection web page 550 comprise a product category selection data entry control. According to yet another embodiment, this web page 550 further comprises a product manufacturer data entry control 560. And still according to another alternative embodiment, the web page 550 further comprises a product model number data entry control 570. One or more of these data entry controls may be a drop-down list.

According to this illustrative use case, the web page constructor 320, as controlled by directives in a web page template, populates the drop-down list corresponding to the product category data entry control 555. Values for the drop-down list, according to one example embodiment of the web page constructor module 320, are obtained from the product category advertisements table 180 by selecting unique values stored in the product category field 185 thereof.

Once a user selects a product category from the drop-down list in the product category data entry control 555, the product category selection is conveyed back to the web server module 315 and then to the page constructor 320. The page constructor 320 responds by querying the database manager 325 to provide a list of all makers in the product category/maker table 200 having the product category field 205 equal to the user's product category selection. This list of makers is then used by the page constructor module to populate the product manufacturer data entry control's 560 drop-down list. Once so populated, the user is able to select a product manufacturer. This new version of the web page is then delivered to the user.

Using the list of manufacturers, the user is able to identify the product manufacturer. This user selection is also received by the web page constructor 320. The web page constructor then interrogates the database manager 325 in order to obtain a list of product model numbers made by the selected manufacturer in the selected product category. Hence, the query submitted to the database manager 325 targets a specific search of the product notice table 250 to find a record according to product category, product maker and product model number.

According to one example embodiment, the advertisements specified in the product category advertisements table 180, the product category/maker advertisements table 200 and the product notice table 250 are all presented to the user as each drop-down list corresponding to the product category data entry control 555, product manufacturer data entry control 560 and the product model number data entry control 570 is populated. These advertisements appear in the web page as reference numbers 580, 590 and 600, respectively.

It should be noted that this illustrative use case is presented here to illustrate the present invention and not to limit the scope thereof. What is important to note is that a user is encouraged to visit a web site. What occurs once the user reaches the web site is not an essential element of the invention. For example, the user, according to one alternative embodiment, would receive a web page comprising a product digital identifier data entry control. Accordingly, the user directly enters a product digital identifier. As is apparent, any type of information query could be used to further target specific types of advertisements to the user. Product identification is merely one example. For instance, perhaps a user's zip code is the only information that the web server would receive from a user. Again, even this is merely an example. The example invention embodiments described here, which result in identification of a product that the user received web site visitation encouragement, are suitable when a web site function is to provide addition information pertaining to the product notice.

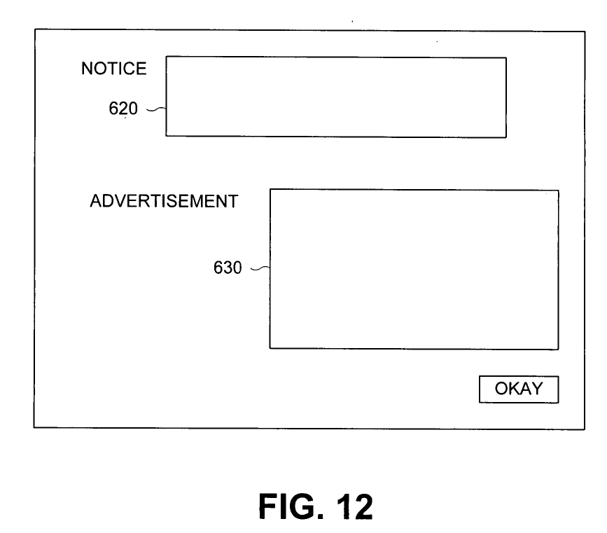

FIG. 12 is a pictorial representation of one example embodiment of a product notice web page prepared for a user by the web page constructor of the present invention. According to one example use case, a template for a product notice web page 610 is described as including a notice data presentation control 620. According to yet another alternative use case, the product notice web page 610 further comprises an advertisement presentation control 630. Once the web page constructor 320 has received user selections that describe a product (e.g. in terms of product category, product maker, product model number or product digital identifier), a product notice is retrieved from the product notice table 250 from a record selected according to the product description. This is then included in the web page (control 620) produced by the web page constructor 320 and then delivered to the user. According to one alternative use case, the web page constructor 320 retrieves an advertisement from the selected record and includes the advertisement (control 630) in the web page and delivers the web page to the user.

While this invention has been described in terms of several preferred embodiments, it is contemplated that alternatives, modifications, permutations, and equivalents thereof will become apparent to those skilled in the art upon a reading of the specification and study of the drawings. It is therefore intended that the true spirit and scope of the present invention include all such alternatives, modifications, permutations, and equivalents.

What is claimed is:

1. A method for encouraging a user to visit a web site comprising issuing a signal to a receiver integrated into a product wherein said receiver comprises a notification means for informing a user that a notice has been received.

2. The method of claim 1 wherein issuing a signal to a receiver comprises:
forming a message comprising web site information; and
directing the message to the product.

3. A method for presenting advertisements to a user comprising:
encouraging a user to visit a web site;
receiving a web page request from the user; and
providing a web page in response to the request.

4. The method of claim 3 wherein encouraging a user to visit a web site comprises requesting the issuance of a product notice signal.

5. The method of claim 3 wherein encouraging a user to visit a web site comprises directing a product notice signal to a product.

6. The method of claim 5 wherein directing a product notice signal to a product comprises:
forming a message; and
directing the message to a receiver integrated into a product.

7. The method of claim 5 wherein directing a product notice signal to a product comprises:
forming a message that includes web site information; and
directing the message to a receiver integrated into a product.

8. The method of claim 3 wherein providing a web page comprises:
receiving information from a user;
selecting an advertisement according to the information;
including the selected advertisement in a web page; and
providing the web page to the user.

9. The method of claim 3 wherein providing a web page comprises:
receiving a product identifier;
selecting an advertisement according to the product identifier;
including the selected advertisement in a web page; and
providing the web page to the user.

10. The method of claim 3 wherein providing a web page comprises:
receiving a product category;
selecting an advertisement according to the product category;
including the selected advertisement in a web page; and
providing the web page to the user.

11. The method of claim 3 wherein providing a web page comprises:
receiving a manufacturer identifier;
selecting an advertisement according to the manufacturer identifier;
including the selected advertisement in a web page; and
providing the web page to the user.
